(19) United States
(12) Patent Application Publication
(10) Pub. No.: US 2025/0003574 A1
(43) Pub. Date: Jan. 2, 2025

(54) LIGHT SOURCE MODULE

(71) Applicant: Qisda Corporation, Taoyuan City (TW)

(72) Inventors: Chih-Shiung Chien, Taoyuan City (TW); Ming-Kuen Lin, Taoyuan City (TW); Tsung-Hsun Wu, Taoyuan City (TW)

(73) Assignee: Qisda Corporation, Taoyuan City (TW)

(21) Appl. No.: 18/638,572

(22) Filed: Apr. 17, 2024

(30) Foreign Application Priority Data
Jun. 27, 2023 (TW) 112123837

(51) Int. Cl. F21V 9/30; F21V 5/00; F21V 7/04; F21V 14/04; G02B 26/00

(52) U.S. Cl. CPC F21V 9/30; F21V 5/008; F21V 7/04; F21V 14/04; G02B 26/008

(57) ABSTRACT

A light source module includes a wavelength conversion unit, a first lens, a second lens, a light path turning device, and a light-emitting device. The first lens is disposed in front of the wavelength conversion unit. The second lens is disposed in front of the first lens. The light path turning device is disposed beside the second lens, and not on an optical axis of the first lens. The light-emitting device is configured to emit a first beam. The first beam is sequentially turned by the light path turning device and penetrates through the first lens to be transmitted to the wavelength conversion unit. The wavelength conversion unit is configured to convert the first beam into a second beam. A wavelength of the first beam is different from that of the second beam. The second beam penetrates through the first lens and the second lens sequentially.

### CROSS-REFERENCE TO RELATED APPLICATION

This application claims the priority benefit of Taiwan application serial no. 112123837, filed on Jun. 27, 2023. The entirety of the above-mentioned patent application is hereby incorporated by reference herein and made a part of this specification.

### BACKGROUND

### Technical Field

The disclosure relates to a light source module.

### Description of Related Art

With the advancement of optoelectronic technology, a light source module that uses a laser beam to excite phosphor to emit fluorescent light has been developed. In this kind of light source module, since the laser beam has high light intensity, it may also excite the fluorescent light with high light intensity, thereby providing a light source with high light intensity.

In order to separate light paths of the laser beam incident on the phosphor and the fluorescent light excited therefrom, a dichroic mirror is adopted in the conventional technology. Specifically, a wavelength of the laser beam will be different from a wavelength of the fluorescent light, and the dichroic mirror will have different reflectivities or transmittances for different wavelength ranges. In addition, the dichroic mirror may be designed to be adapted to reflect the laser beam, and is adapted to allow the fluorescent light to penetrate through. In this way, the laser beam from a laser light source may be reflected by the dichroic mirror and then converged to the phosphor through a lens to excite the fluorescent light. The fluorescent light penetrates through the dichroic mirror after being collimated by the lens, and after penetrating through the dichroic mirror, it is separated from the light path of the laser beam, and will not illuminate the laser light source.

Although the above structure adopting the dichroic mirror may separate the light paths of the fluorescent light and the laser beam such that the fluorescent light will not be transmitted back to the laser light source, the dichroic mirror also takes up space in front of the lens, making an optical system larger.

### SUMMARY

The disclosure provides a light source module, which may have a smaller volume and lower cost.

An embodiment of the disclosure provides a light source module, includes a wavelength conversion unit, a first lens, a second lens, a light path turning device, and a light-emitting device. The first lens is disposed in front of the wavelength conversion unit, and the second lens is disposed in front of the first lens. The light path turning device is disposed beside the second lens, and not on an optical axis of the first lens. The light-emitting device is disposed beside the first lens, and is configured to emit a first beam. The first beam is sequentially turned by the light path turning device and penetrates through the first lens to be transmitted to the wavelength conversion unit. The wavelength conversion unit is configured to convert the first beam into a second beam. A wavelength of the first beam is different from a wavelength of the second beam. The second beam penetrates through the first lens and the second lens sequentially.

In the light source module according to the embodiment of the disclosure, the light path turning device is disposed beside the second lens, and not on the optical axis of the first lens. The first beam is sequentially turned by the light path turning device and penetrates through the first lens to be transmitted to the wavelength conversion unit, and the second beam penetrates through the first lens and the second lens sequentially. Therefore, through such a design, the effect of separating the light paths of the first beam and the second beam may be achieved in a smaller space, and there is no need to use the dichroic mirror that takes up space in front of the first lens and the second lens. Therefore, the light source module in this embodiment may have a smaller volume and lower cost.

### BRIEF DESCRIPTION OF THE DRAWINGS

FIG. 1 is a schematic view of a light path of a light source module according to an embodiment of the disclosure.

FIG. 2 is a schematic view of a light path of a light source module according to another

embodiment of the disclosure.

FIG. 3 is a schematic view of a light path of a light source module according to still another embodiment of the disclosure.

FIG. 4 is a schematic view of a light path of a light source module according to yet another embodiment of the disclosure.

FIG. 5 is a schematic view of a light path of a light source module according to another embodiment of the disclosure.

FIG. 6 is a schematic view of a light path of a light source module according to still another embodiment of the disclosure.

### DETAILED DESCRIPTION OF DISCLOSED EMBODIMENTS

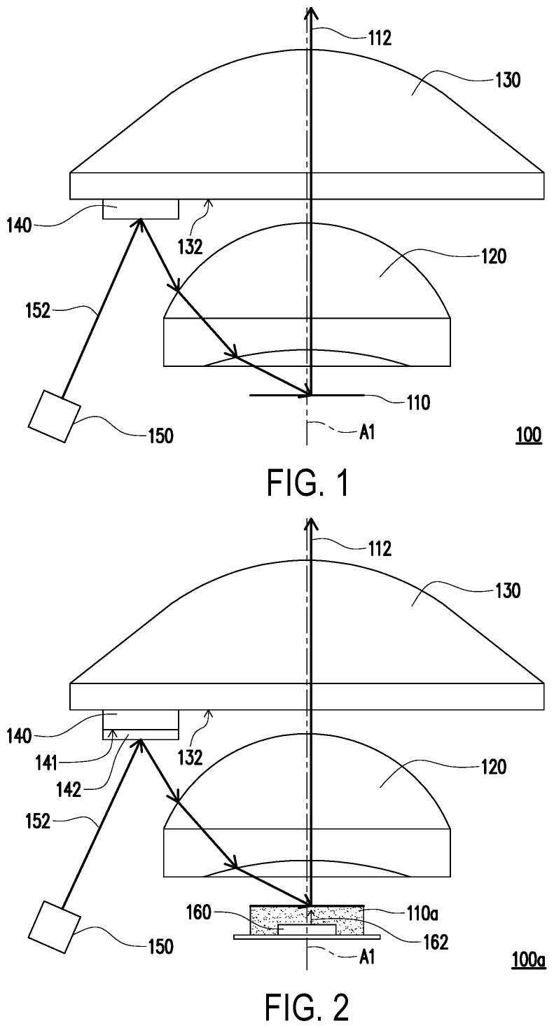

FIG. 1 is a schematic view of a light path of a light source module according to an embodiment of the disclosure. Referring to FIG. 1, a light source module 100 in this embodiment includes a wavelength conversion unit 110, a first lens 120, a second lens 130, a light path turning device 140, and a light-emitting device 150. In this embodiment, the wavelength conversion unit 110 is a phosphor layer or a phosphor rotating wheel. The first lens 120 is disposed in front of the wavelength conversion unit 110, and the second lens 130 is disposed in front of the first lens 120. The light path turning device 140 is disposed beside the second lens 130, and not located on an optical axis A1 of the first lens 120. The light-emitting device 150 is disposed beside the first lens 120, and is configured to emit a first beam 152. The first beam 152 is sequentially turned by the light path turning device 140 and penetrates the first lens 120 to be transmitted to the wavelength conversion unit 110. In this embodiment, the first beam 152 emitted by the light-emitting device 150 is transmitted to the light path turning device 140 in a space on a side of the first lens 120 away from the optical axis A1. In addition, in this embodiment, the light path turning device 140 is a reflector to reflect the first beam 152 emitted by the light-emitting device 150 to the wavelength conversion unit 110. Specifically, the light path turning device 140 reflects the first beam 152 from the light-emitting device 150 to the first lens 120, and then the first beam 152 penetrates through the first lens 120 to be transmitted to the wavelength conversion unit 110. In this embodiment, the first beam 152 turned by the light path turning device 140 is obliquely incident on the first lens 120. In an embodiment, the first lens 120 may converge the nearly parallel first beam 152 onto the wavelength conversion unit 110. In addition, in this embodiment, the light path turning device 140 is disposed on a surface 132 of the second lens 130 facing the first lens 120.

In this embodiment, the light-emitting device 150 is a laser light source, such as a laser diode, and the first beam 152 is a laser beam. The wavelength conversion unit 110 is configured to convert the first beam 152 into a second beam 112. A wavelength of the first beam 152 is different from a wavelength of the second beam 112. For example, when the wavelength conversion unit 110 is the phosphor layer or the phosphor rotating wheel, the first beam 152 excites phosphor on the phosphor layer or the phosphor rotating wheel to generate fluorescent light. The fluorescent light is the second beam 112. Then, the second beam 112 sequentially penetrates through the first lens 120 and the second lens 130 to be transmitted to an outside world to provide illumination to the outside world. When the wavelength conversion unit 110 is the phosphor rotating wheel, the phosphor rotating wheel may continuously rotate, so that different portion of the phosphor layer are illuminated by the first beam 152 sequentially, so as to achieve a dispersion effect of a heat source and prevent heat from accumulating on the phosphor layer.

In the light source module 100 in this embodiment, the light path turning device 140 is disposed beside the second lens 130, and is not located on the optical axis A1 of the first lens 120. The first beam 152 is sequentially turned by the light path turning device 140 and penetrates through the first lens 120 to be transmitted to the wavelength conversion unit 110, and the second beam 112 penetrates through the first lens 120 and the second lens 130 sequentially. Therefore, through such a design, an effect of separating light paths of the first beam 152 and the second beam 112 may be achieved in a smaller space, and there is no need to use a dichroic mirror that takes up space in front of the first lens 120 and the second lens 130. Therefore, the light source module 100 in this embodiment may have a smaller volume and lower cost.

In this embodiment, the light source module 100 may be a headlight of a vehicle. The first beam 152 is, for example, blue light, and the second beam 112 is, for example, yellow light. A reflective substrate may be disposed below the phosphor layer of the wavelength conversion unit 110. In addition to reflecting the second beam 112 to the first lens 120, in an embodiment, the reflective substrate may also reflect the first beam 152 that is not converted by the phosphor layer to the first lens 120. In this way, the yellow second beam 112 and the blue unconverted first beam 152 may be mixed into white light, and penetrates through the first lens 120 and the second lens 130 sequentially to be transmitted to the outside world, thereby forming white light illumination. However, in other embodiments, the first beam 152 and the second beam 112 may also be beams of other colors or wavelengths. For example, the first beam 152 may also be ultraviolet light, and the second beam 112 may be white light.

In this embodiment, both the first lens 120 and the second lens 130 may be convex lenses. In one embodiment, the first lens 120 is a concave-convex lens, and the second lens 130 is a plano-convex lens. However, in other embodiments, the first lens 120 and the second lens 130 may also be other similar convex lenses, such as biconvex lenses. In addition, in other embodiments, the second lens 130 may also be a concave lens, and types of the first lens 120 and the second lens 130 are not limited to the above.

FIG. 2 is a schematic view of a light path of a light source module according to another embodiment of the disclosure. Referring to FIG. 2, a light source module 100a in this embodiment is similar to the light source module 100 in FIG. 1, and a main difference between the two is as follows. In the light source module 100a in this embodiment, the light path turning device 140 has a reflective surface 141 facing away from the second lens 130, and a light homogenizing element 142 is disposed on the reflective surface 141. The light homogenizing element 142 is, for example, a diffuser or a fly-eye lens.

In this embodiment, the light source module 100a further includes another light-emitting device 160. A wavelength conversion unit 110a is disposed between the light-emitting device 160 and the first lens 120, and is configured to convert a beam 162 emitted by the light-emitting device 160 into the second beam 112. The wavelength of the second beam 112 is different from a wavelength of the beam 162 emitted by the light-emitting device 160. Specifically, in this embodiment, the light-emitting device 160 is a light-emitting diode chip, and the wavelength conversion unit 110a is a phosphor layer covering the light-emitting diode chip.

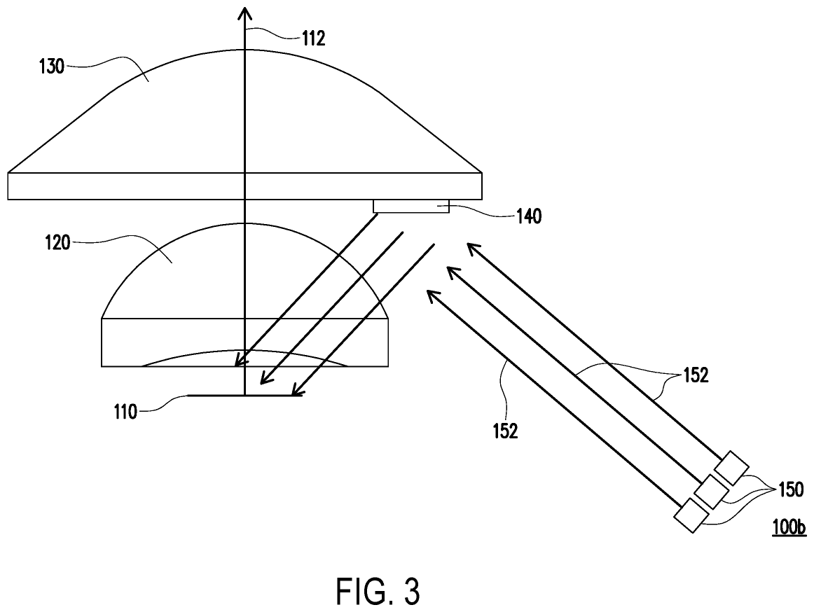

FIG. 3 is a schematic view of a light path of a light source module according to still another embodiment of the disclosure. Referring to FIG. 3, a light source module 100b in this embodiment is similar to the light source module 100 in FIG. 1, and a main difference between the two is as follows. The light source module 100b in this embodiment includes multiple light-emitting devices 150 to respectively emit multiple first beams 152. The light path turning device 140 is configured to turn the first beams 152 to the wavelength conversion unit 110.

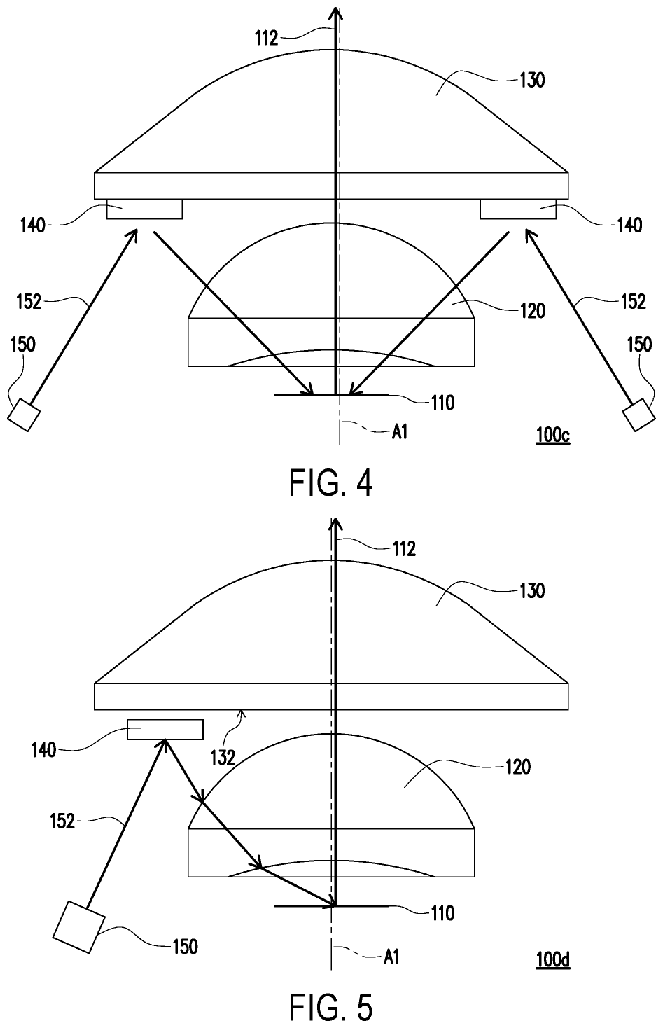

FIG. 4 is a schematic view of a light path of a light source module according to yet another embodiment of the disclosure. Referring to FIG. 4, a light source module 100c in this embodiment is similar to the light source module 100 in FIG. 1, and a main difference between the two is as follows. The light source module 100c in this embodiment includes the light-emitting devices 150 and multiple light path turning devices 140. The light-emitting devices 150 are configured to emit the first beams 152 respectively, and the light path turning devices 140 are configured to turn the first beams 152 to the wavelength conversion unit 110 respectively. In this embodiment, configuration positions of the light path turning devices 140 include positions on two opposite sides of the optical axis A1 of the first lens 120, and configuration positions of the light-emitting devices 150 include the positions on the two opposite sides of the optical axis A1 of the first lens 120.

FIG. 5 is a schematic view of a light path of a light source module according to another embodiment of the disclosure. Referring to FIG. 5, a light source module 100d in this embodiment is similar to the light source module 100 in FIG. 1, and a main difference between the two is as follows. In the light source module 100d in this embodiment, the surface 132 of the second lens 130 facing the first lens 120 also faces the light path turning device 140, and there is a gap between the light path turning device 140 and the second lens 130.

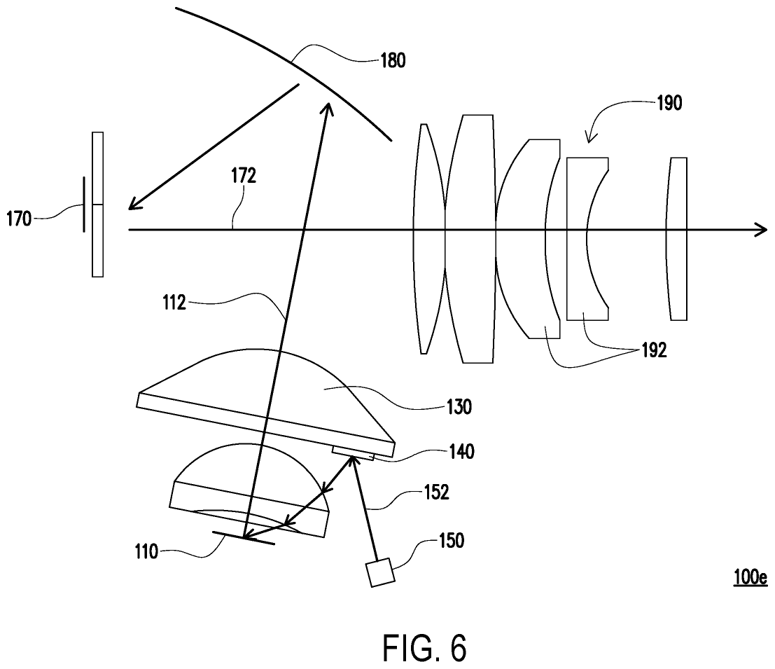

FIG. 6 is a schematic view of a light path of a light source module according to still another embodiment of the disclosure. Referring to FIG. 6, a light source module 100e in this embodiment is similar to the light source module 100 in FIG. 1, and a main difference between the two is as follows. The light source module 100e in this embodiment further includes a light valve 170 disposed on a path of the second beam 112 from the second lens 130 and configured to convert the second beam 112 into an image beam 172. The light valve 170 is, for example, a digital micro-mirror device (DMD).

In this embodiment, the light source module 100e further includes a concave mirror 180 disposed on the path of the second beam 112 from the second lens 130 and configured to reflect the second beam 112 to the light valve 170. In addition, in this embodiment, the light source module 100e further includes a photographic lens 190 disposed on a path of the image beam 172 from the light valve 170 and configured to project the image beam 172 to the outside world to provide illumination to the outside world. The light source module 100e is a headlight of a vehicle, such as an adaptive driving beam (ADB). That is, the image beam 172 is changed by the light valve 170 to form different illumination areas, patterns, or text, or the image beam 172 may be projected to a distant place through the photographic lens 190. The photographic lens 190 may include at least one lens 192, and in FIG. 6, multiple lenses are taken as an example.

In other embodiments, the light valve 170 and the photographic lens 190 may also be disposed in front of the second lens 130 of the light source modules 100a to 100d in FIGS. 2 to 5 as shown in FIG. 6 (the concave mirror 180 in FIG. 6 may also be disposed) to form other variant embodiments of the adaptive driving beam.

Based on the above, in the light source module according to the embodiment of the

disclosure, the light path turning device is disposed beside the second lens, and not on the optical axis of the first lens. The first beam is sequentially turned by the light path turning device and penetrates through the first lens to be transmitted to the wavelength conversion unit, and the second beam penetrates through the first lens and the second lens sequentially. Therefore, through such a design, the effect of separating the light paths of the first beam and the second beam may be achieved in a smaller space, and there is no need to use the dichroic mirror that takes up space in front of the first lens and the second lens. Therefore, the light source module in this embodiment may have a smaller volume and lower cost.

What is claimed is:

1. A light source module, comprising:
a wavelength conversion unit;
a first lens disposed in front of the wavelength conversion unit;
a second lens disposed in front of the first lens;
a light path turning device disposed beside the second lens and not on an optical axis of the first lens; and
a light-emitting device disposed beside the first lens and configured to emit a first beam, wherein the first beam is sequentially turned by the light path turning device and penetrates through the first lens to be transmitted to the wavelength conversion unit, the wavelength conversion unit is configured to convert the first beam into a second beam, a wavelength of the first beam is different from a wavelength of the second beam, and the second beam penetrates through the first lens and the second lens sequentially.

2. The light source module according to claim 1, wherein the first beam emitted by the light-emitting device is transmitted to the light path turning device in a space on a side of the first lens away from the optical axis.

3. The light source module according to claim 1, wherein the light path turning device has a reflective surface facing away from the second lens, and a light homogenizing element is disposed on the reflective surface.

4. The light source module according to claim 3, wherein the light homogenizing element is a diffuser or a fly-eye lens.

5. The light source module according to claim 1, further comprising another light-emitting device, wherein the wavelength conversion unit is disposed between the another light-emitting device and the first lens and configured to convert a beam emitted by the another light-emitting device into the second beam, and the wavelength of the second beam is different from a wavelength of the beam emitted by the another light-emitting device.

6. The light source module according to claim 5, wherein the another light-emitting device is a light-emitting diode chip, and the wavelength conversion unit is a phosphor layer covering the light-emitting diode chip.

7. The light source module according to claim 1, further comprising a plurality of the light-emitting devices to emit a plurality of the first beams respectively, wherein the light path turning device is configured to turn the first beams to the wavelength conversion unit.

8. The light source module according to claim 1, further comprising a plurality of the light-emitting devices and a plurality of the light path turning devices, wherein the light-emitting devices are configured to emit a plurality of the first beams respectively, and the light path turning devices are configured to turn the first beams to the wavelength conversion unit respectively.

9. The light source module according to claim 1, wherein configuration positions of the light path turning devices comprise positions on two opposite sides of the optical axis of the first lens, and configuration positions of the light-emitting devices comprise the positions on the two opposite sides of the optical axis of the first lens.

10. The light source module according to claim 1, wherein the wavelength conversion unit is a phosphor layer or a phosphor rotating wheel.

11. The light source module according to claim 1, wherein the first beam turned by the light path turning device is obliquely incident on the first lens.

12. The light source module according to claim 1, further comprising a light valve disposed on a path of the second beam from the second lens and configured to convert the second beam into an image beam.

13. The light source module according to claim 12, wherein the light valve is a digital micro-mirror device.

14. The light source module according to claim 12, further comprising a concave mirror disposed on the path of the second beam from the second lens and configured to reflect the second beam to the light valve.

15. The light source module according to claim 12, further comprising a photographic lens disposed on a path of the image beam from the light valve and configured to project the image beam to an outside world, wherein the light source module is a headlight of a vehicle.

16. The light source module according to claim 1, wherein a surface of the second lens facing the first lens also faces the light path turning device, and there is a gap between the light path turning device and the second lens.

17. The light source module according to claim 1, wherein the light path turning device is disposed on a surface of the second lens facing the first lens.

18. The light source module according to claim 1, wherein the light path turning device is a reflector to reflect the first beam emitted by the light-emitting device to the wavelength conversion unit.
